(19) United States
(12) Patent Application Publication
(10) Pub. No.: US 2025/0124817 A1
(43) Pub. Date: Apr. 17, 2025

(54) Pulse Wave Reproduction Device and Method of Operating the Same

(71) Applicant: Korea Advanced Institute of Science and Technology, Daejeon (KR)

(72) Inventors: Yong-Hwa PARK, Daejeon (KR); Jae-Hak JEONG, Daejeon (KR); Bomi LEE, Daejeon (KR); Junki HONG, Daejeon (KR); Changhee MIN, Daejeon (KR); Adelle Ria PERSAD, Daejeon (KR)

(21) Appl. No.: 18/663,199

(22) Filed: May 14, 2024

(30) Foreign Application Priority Data
Oct. 17, 2023 (KR) 10-2023-0138738

(51) Int. Cl. G09B 23/30

(52) U.S. Cl. CPC G09B 23/303

(57) ABSTRACT

Disclosed are a pulse wave reproduction device and a method of operating the same according to the present invention, the pulse wave reproduction device including an aorta part provided in the form of a tube elongated to correspond to a shape of a human aorta and configured such that a circulation fluid flows in the aorta part, a heart part connected to the aorta part and configured to share the circulation fluid with aorta part and generate a forward wave according to a pulse flow by applying a pressure in a preset cycle, a vein part configured to share the circulation fluid with aorta part and adjust a pressure in the aorta part by applying a pressure to the circulation fluid, and a pressure environment creation part having a space therein to accommodate the aorta part and configured to adjust an external pressure by pressing the aorta part.

### TECHNICAL FIELD

The present invention relates to a pulse wave reproduction device, and more particularly, to a pulse wave reproduction device and a method of operating the same, which are capable of reproducing a pulse wave of a human aorta by adjusting the pressure of an artificial aorta.

### BACKGROUND ART

With increasing life expectancy and medical advances, the importance of cardiovascular health is recognized. Blood pressure is considered the most basic cardiovascular health indicator, and various characteristics, such as maximum blood pressure, minimum blood pressure, increase/decrease points, and pulse wave velocities, are shown in blood pressure waveforms.

Therefore, studies on the estimation of cardiovascular parameters from the blood pressure waveforms have been actively conducted. However, there are limitations, such as clinical data biased toward the elderly and patients, and difficulty in controlling variables.

In addition, with increasing average lifespans and medical and medicine advances, the importance of cardiovascular health is emphasized, and medical devices, wearable devices, smart watches, and the like for monitoring the cardiovascular health are being actively developed. Blood pressure is considered the most basic cardiovascular health indicator, and various characteristics, such as increase/decrease points and pulse wave velocities as well as maximum blood pressure and minimum blood pressure, are shown in blood pressure waveforms. Therefore, studies on the estimation of cardiovascular parameters from the blood pressure waveforms have been actively conducted. However, there are limitations, such as clinical data biased toward the elderly and patients, and difficulty in controlling variables. Clinical databases for some pulse waves are publicly available and utilized in related studies. However, most of the clinical databases are related to indirect pulse wave signals such as ECG and PPG, and the blood pressure signals, which exist as part of clinical databases, are limited to signals measured at the radial artery at the wrist. A small-scale database related to central blood pressure waveforms measured from an aortic arch exists. However, because this database is indirectly estimated from brachial cuffs in a non-invasive manner, the accuracy is debatable.

Therefore, in order to study the blood pressure waveform that contains key information about human cardiovascular health, numerical analysis model, hardware simulators, artificial blood vessels, and the like have been studied. The numerical analysis model requires many assumptions and approximations to simulate complex blood vessels with periodic pulsation of a fluid in an elastic tube. There are studies that have built the blood pressure waveform DB based on 1D models, but the blood pressure waveforms are different from human blood pressure waveforms.

In order to perform more accurate experiments, studies have been conducted to develop a pulse wave reproduction device that mimics the human cardiovascular system. However, these studies are inadequate for reproducing blood pressure waveforms because the studies deal only with the atrial-ventricular relationship, or the studies are intended to evaluate the performance of medical devices such as prosthetic valves, and train medical personnel in surgery. In particular, the stiffness of the blood vessel differs significantly from that of the human body because rigid PVC is used to determine the stiffness of blood vessels that is a key factor in reproducing blood pressure waveforms. Therefore, research has been conducted on artificial blood vessels with properties similar to human blood vessels. However, these studies have used a material mechanics approach to fabrication that involves laminating meshes or silicone having different stiffnesses onto silicone, and this fabrication method is limited to plates. Therefore, these studies are not suitable for realizing complex vessel geometries with varying diameters and branching. Because these preceding studies do not simultaneously simulate the geometry and properties of the human cardiovascular system, the studies cannot implement formation principles of blood pressure waveforms, even if the waveforms and magnitudes are similar to those of the human cardiovascular system.

### DISCLOSURE

### Technical Problem

The present invention has been made in an effort to solve the above-mentioned problem in the related art, and an object of the present invention is to provide a pulse wave reproduction device and a method of operating the same, which are capable of reproducing a cardiovascular system identical to a human cardiovascular system and reproducing a blood pressure waveform and a pulse wave velocity identical to those of a human body.

Technical problems of the present invention are not limited to the aforementioned technical problems, and other technical problems, which are not mentioned above, may be clearly understood by those skilled in the art from the following descriptions.

### Technical Solution

In order to achieve the above-mentioned object, the present invention provides a pulse wave reproduction device and a method of operating the same according to the present invention, the pulse wave reproduction device including an aorta part provided in the form of a tube elongated to correspond to a shape of a human aorta and configured such that a circulation fluid flows in the aorta part, a heart part connected to the aorta part and configured to share the circulation fluid with aorta part and generate a forward wave according to a pulse flow by applying a pressure in a preset cycle, a vein part configured to share the circulation fluid with aorta part and adjust a pressure in the aorta part by applying a pressure to the circulation fluid, and a pressure environment creation part having a space therein to accommodate the aorta part and configured to adjust an external pressure by pressing the aorta part.

Further, internal and external pressures of the aorta part may be adjusted to reproduce a condition of the human aorta.

Further, the aorta part may include: an aorta hole member protruding outward from a periphery of the aorta part; and a third pressure sensor coupled to the aorta hole member and configured to measure the internal pressure of the aorta part.

Further, the pressure environment creation part may be shaped to surround the aorta part and partially opened so that the aorta part is inserted into the pressure environment creation part, and at least a part of the pressure environment creation part may include a second pump configured to apply a pressure to the aorta part.

In addition, the pressure environment creation part may include a door configured to open or close a part of the pressure environment creation part to replace the aorta part, and the second pump may be coupled to the door and apply a pressure into the pressure environment creation part.

Further, the pressure environment creation part may be provided as a plurality of pressure environment creation parts coupled to one another in accordance with a length of the aorta part and formed in different shapes while corresponding to a shape of the aorta part.

In addition, the vein part may be connected to the aorta part and configured to share the circulation fluid in the aorta part, adjust an internal pressure of the aorta part, and measure the internal pressure of the aorta part.

Further, the vein part may include: a vein hole member extending from a distal end of the aorta part; a first pump connected to the vein hole member and configured to pressurize the circulation fluid in the aorta part; and a first pressure sensor disposed adjacent to the first pump and configured to measure a pressure in the aorta part.

In addition, the heart part may include: a pump member configured to provide a pulse flow to the aorta part through the circulation fluid; and valve members provided between the pump member and the aorta part, between the pump member and the vein part, and between the vein part and the aorta part and configured to allow the pulse flow to be provided only in one direction from the pump member toward the aorta part.

### Advantageous Effects

According to the present invention, it is possible to reproduce an artificial aorta with a shape and physical properties similar to those of the human body to reproduce the blood pressure waveform and the magnitude of the blood pressure waveform.

Further, it is possible to measure the blood pressure waveform in relation to age by manufacturing the artificial aortas with different physical properties.

In addition, it is possible to adjust the internal and external pressures of the artificial aorta.

Further, it is possible to adjust cardiovascular health conditions, such as heart rates, cardiac outputs, and peripheral resistance, and reproduce the blood pressure waveform in relation to the corresponding condition.

The effects of the present invention are not limited to the aforementioned effects, and other effects, which are not mentioned above, will be clearly understood by those skilled in the art from the claims.

### DESCRIPTION OF DRAWINGS

FIG. 1 is a view for explaining an entire configuration of a pulse wave reproduction device according to an embodiment of the present invention.

FIG. 2 is a view for explaining an internal configuration of the pulse wave reproduction device according to the embodiment of the present invention.

FIG. 3 is a view for explaining an aorta part of the pulse wave reproduction device according to the embodiment of the present invention.

FIG. 4 is a view for explaining a pressure environment creation part of the pulse wave reproduction device according to the embodiment of the present invention.

FIG. 5 is a view for explaining operations of a vein part and the pressure environment creation part for implementing a pressure balance of the aorta part of the pulse wave reproduction device according to the embodiment of the present invention.

FIG. 6 is a view for explaining a process in which aorta parts with different physical properties are replaced to perform a simulation for each condition in the pulse wave reproduction device according to the embodiment of the present invention.

FIG. 7 is a view for explaining a pulse wave reproduction method using the pulse wave reproduction device according to the embodiment of the present invention.

FIGS. 8 and 9 are views for explaining pulse wave measurement values obtained on the basis of the presence or absence of the pressure environment creation part by the pulse wave reproduction method using the pulse wave reproduction device according to the embodiment of the present invention.

FIG. 10 is a view for explaining a result value for deriving a waveform similar to that of a human body by means of the pulse wave reproduction device in the pulse wave reproduction method using the pulse wave reproduction device according to the embodiment of the present invention.

### MODE FOR INVENTION

Hereinafter, exemplary embodiments of the present invention will be described in detail with reference to the accompanying drawings. First, the present invention will be described in detail with reference to the same drawings in giving reference numerals to constituent elements in the drawings.

It should be noted that the same constituent elements will be designated by the same reference numerals, if possible, even though the constituent elements are illustrated in different drawings. In addition, in the description of the present invention, the specific descriptions of publicly known related configurations or functions will be omitted. Hereinafter, exemplary embodiments of the present invention will be described in detail with reference to the accompanying drawings. First, in giving reference numerals to constituent elements of the respective drawings, it should be noted that the same constituent elements will be designated by the same reference numerals, if possible, even though the constituent elements are illustrated in different drawings. In addition, in the description of the present invention, the specific descriptions of publicly known related configurations or functions will be omitted when it is determined that the specific descriptions may obscure the subject matter of the present invention.

Various aspects of the present invention will be described below. It should be understood that the inventions presented herein may be implemented in a wide variety of different forms and that any particular structure, function, or both presented herein are merely exemplary. Based on the inventions presented herein, those skilled in the art will understand that any one aspect presented herein may be implemented independently of any other aspect, and that two or more such aspects may be combined in various ways. For example, devices may be implemented or methods may be practiced using any number of aspects described herein. In addition, such devices may be implemented or methods may be practiced utilizing other structures, features, or structures and features in addition to or instead of one or more of the aspects described herein.

The present invention will be described in detail with reference to the drawings.

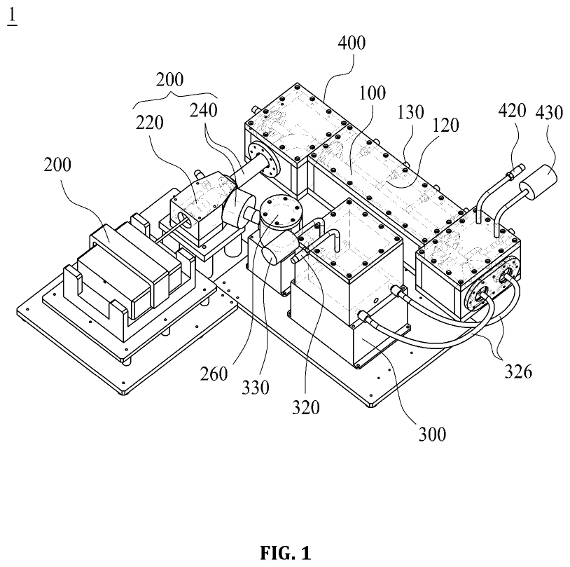

FIG. 1 is a view for explaining an entire configuration of a pulse wave reproduction device according to an embodiment of the present invention.

The present invention relates to a hardware simulator for reproducing a blood pressure waveform and a magnitude of a human body, i.e., to a device for implementing an artificial aorta with a shape and physical properties similar to those of a human body, thereby reproducing maximum blood pressure of 120 mmHg, minimum blood pressure of 80 mmHg, and a shape of a blood pressure waveform made by the superposition of a forward wave and a reflective wave.

As illustrated, the pulse wave reproduction device according to the present invention may broadly include an aorta part 100, a heart part 200, a vein part 300, and a pressure environment creation part 400.

The aorta part 100 may have a magnitude and shape almost similar to a magnitude and shape of a human aorta.

Specifically, the aorta part 100 may have an overall length of 712 mm, a thickness of 2 mm, an inner diameter of 28 mm to 14 mm, and a pulse wave velocity of 6.53 m/s. The aorta part 100 may have physical properties including rigidity of 365 kPa.

Further, the aorta part 100 may be provided so that a circulation fluid 10 flows therein. Although not illustrated in FIG. 1, the aorta part 100 may be accommodated in the pressure environment creation part 400.

Further, the heart part 200 may be connected to an upper portion of the aorta part 100 and generate a forward wave according to a pulse flow by applying pressure in a preset cycle while sharing the aorta part 100 and the circulation fluid 10.

The vein part 300 may be connected to a lower portion of the aorta part 100 and share the aorta part 100 and the circulation fluid 10. In this case, the vein part 300 may adjust an internal pressure of the aorta part 100.

In this case, the vein part 300 may directly pressurize the circulation fluid 10 to adjust the internal pressure of the aorta part 100. The structural features of the vein part 300, which adjusts the internal pressure of the aorta part 100, will be described below.

Further, a space may be formed in the pressure environment creation part 400 and provided to accommodate the aorta part 100. A part of the pressure environment creation part 400 may adjust an external pressure by applying the pressure to the aorta part 100.

The present invention is mainly characterized by adjusting the tension of the aorta part 100 by adjusting the internal pressure and the external pressure of the aorta part 100, as described above.

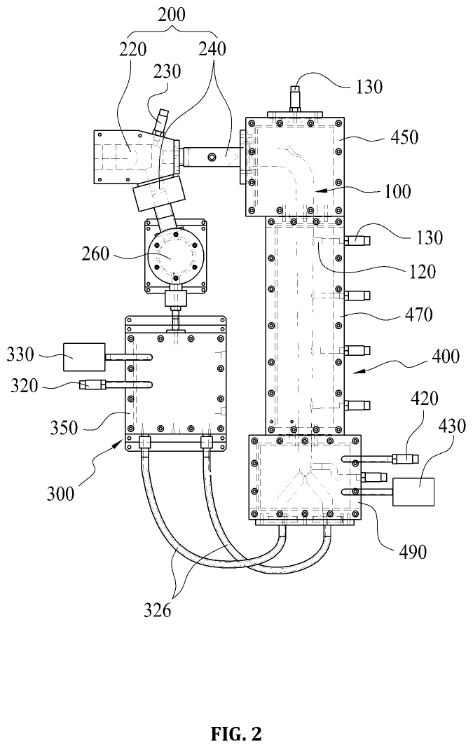

Next, the configuration and structure of the present invention will be described in detail with reference to FIGS. 2 to 4.

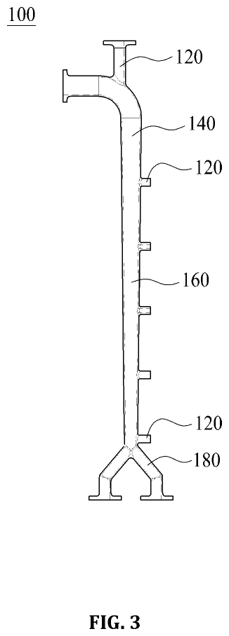

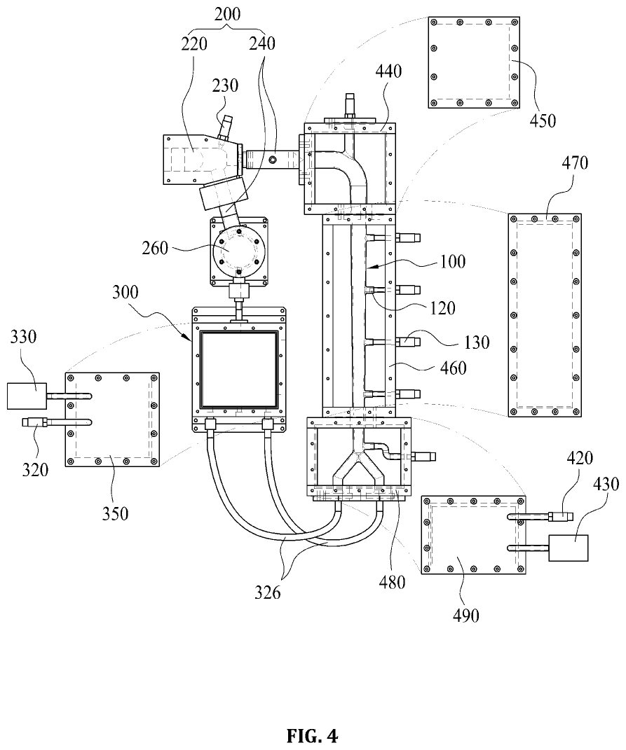

FIG. 2 is a view for explaining an internal configuration of the pulse wave reproduction device according to the embodiment of the present invention, FIG. 3 is a view for explaining the aorta part 100 of the pulse wave reproduction device according to the embodiment of the present invention, and FIG. 4 is a view for explaining the pressure environment creation part 400 of the pulse wave reproduction device according to the embodiment of the present invention.

FIG. 2 is a view illustrating the internal configuration so that the internal configuration may be identified.

First, with reference to the internal configuration of the pressure environment creation part 400, the aorta part 100 may be identified as being elongated downward from above.

It can be ascertained that the upper portion of the aorta part 100 has a shape bent laterally, and is bent and connected to the heart part 200.

The lower portion of the aorta part 100 has a shape divided in two directions, and this is to make a shape identical to a shape in which distal ends of the human aorta are connected to two legs.

In the present invention, the pulse wave reproduction device may include a vein hole member 326 configured to connect the lower portion of the aorta part 100 to the vein part 300.

In this case, the vein part 300 including the vein hole member 326 may be separately provided outside the pressure environment creation part 400.

As described above, the circulation fluid 10 has a closed route in the heart part 200, the aorta part 100, and the vein part 300, and a pump member 220 provided in the heart part 200 may generate the pulse flow by instantaneously pressurizing the circulation fluid 10, like the beating of a human heart.

In addition, an atrium member 260, which serves as a human atrium, is connected to the heart part 200 and disposed between the vein part 300 and the heart part 200. The atrium member 260 may serve as a buffer for adjusting a flow rate of the circulation fluid 10.

In this case, valve members 240 with a flap shape may be provided based on the heart part 200 to circulate the circulation fluid through the heart part 200 and the aorta part 100, circulate the circulation fluid from the aorta part 100 to the vein part 300, and circulate the circulation fluid again toward the heart part 200 in one direction.

Specifically, the valve members 240 may be provided between the pump member 220 and the upper portion of the aorta part 100, between the atrium member 260 and the pump member 220, and between the vein part 300 and the atrium member 260.

Further, the valve members 240 may be respectively provided between the atrium member 260 and the vein part 300 and provided in the vein hole member 326 that connects a distal end of the aorta part 100 and the vein part 300, such that the fluid 10 may circulate in one direction.

The valve member 240 has a flap shape and allows the circulation fluid 10 to pulse flow in one direction. According to the embodiment of the present invention, the valve member 240 has a flap shape. However, the valve member 240 may be a one-way valve with various shapes in case that the valve member 240 is movable in one direction.

Meanwhile, the pressure environment creation part 400 may have a structure that seals the aorta part 100 in all directions to accommodate the entire aorta part 100. This is to maintain the constant internal and external pressures of the aorta part 100, and thus the aorta part 100 may be detachably coupled to the pressure environment creation part 400.

The shape of the aorta part 100 will be described with reference to FIG. 3.

As illustrated in FIG. 3, the aorta part 100 may have a plurality of aorta hole members 120 formed outward.

A third pressure sensor 130 is coupled to the aorta hole member 120 to allow the pressure environment creation part 400 to measure the internal pressure of the aorta part 100. The aorta hole member 120 may be formed in a tubular shape on a surface of the aorta part 100.

The plurality of aorta hole members 120 may be formed on the aorta part 100. When the aorta part 100 is divided into sections, the plurality of aorta hole members 120 may be respectively formed on an upper member 140, an intermediate member 160, and a lower member 180.

First, the intermediate member 160 may be a part elongated at a center of the aorta part 100, and the upper member 140, which is bent toward the heart part 200, may be provided above the intermediate member 160. The lower member 180, which is divided into two opposite sides, may be provided below the intermediate member 160.

In this case, in order to apply the constant pressure to the entire aorta part 100, the pressure environment creation part 400 may adjust a pressure outside the aorta part 100 by adjusting the internal pressure.

The structure in which the pressure environment creation part 400 presses the aorta part 100 will be described with reference to FIG. 4.

The pressure environment creation part 400 may include a second pressure sensor 420 to press the aorta part 100.

The second pressure sensor 420 is elongated, penetrates the pressure environment creation part 400, and measures the pressure in the pressure environment creation part 400. A second pump 430 may be provided adjacent to the second pressure sensor 420 of the pressure environment creation part 400 and adjust the pressure for pressing the aorta part 100.

The second pump 430 may include a motor provided outside the pressure environment creation part 400, and a tube configured to penetrate the pressure environment creation part 400 from the motor. The second pump 430 may adjust the pressure outside the aorta part 100 by providing the pressure into the pressure environment creation part 400.

The second pressure sensor 420 and the second pump 430 are provided on a door of the pressure environment creation part 400, and the door of the pressure environment creation part 400 will be described below.

In the present invention, the second pump is shaped like a motor. However, this is provided for illustrative purposes only, and the second pump may have a screw shape.

Meanwhile, as described above, the pressure environment creation part 400 may have a structure opened at one side thereof so that the aorta part 100 may be replaced.

First, the pressure environment creation part 400 may be provided in the form of a casing divided into different shapes to correspond to the upper member 140, the intermediate member 160, and the lower member 180.

Specifically, the pressure environment creation part 400 may include an upper casing 440 configured to seal the upper member 140, and an upper door 450 detachably coupled to the upper casing 440 and configured to open or close one open side of the upper casing 440. The pressure environment creation part 400 may include an intermediate casing 460 configured to seal the intermediate member 160, and an intermediate door 470 detachably coupled to the intermediate casing 460 and configured to open or close one open side of the intermediate casing 460. The pressure environment creation part 400 may include a lower casing 480 configured to seal the lower member 180, and a lower door 490 detachably coupled to the lower casing 480 and configured to open or close one open side of the lower casing 480.

A sealing mechanism may be provided in case that the casings 440, 460, and 480 and the doors 450, 470, and 490 are coupled to one another.

The pressure environment creation part 400 may have a structure that seals the aorta part 100 accommodated therein.

Further, as described above, the second pressure sensor 420 and the second pump 430 may be coupled to the lower door 490.

Therefore, the second pressure sensor 420 and the second pump 430, together with the lower door 490, may be separated from the pressure environment creation part 400.

Meanwhile, the vein part 300, which adjusts the internal pressure of the aorta part 100, may share the circulation fluid 10 in the aorta part 100, and a part of the vein part 300 may include a first pump 330 configured to pressurize the circulation fluid 10, and a first pressure sensor 320 connected to the inside of the aorta part 100, disposed adjacent to the first pump 330, and configured to detect the pressure in the aorta part 100.

In this case, the vein part 300 may further include a casing (not illustrated) having a space therein and partially opened, and a vein part door 350 openably and closably coupled to the casing.

Further, the first pressure sensor 320 and the first pump 330 may be coupled to the vein part door 350.

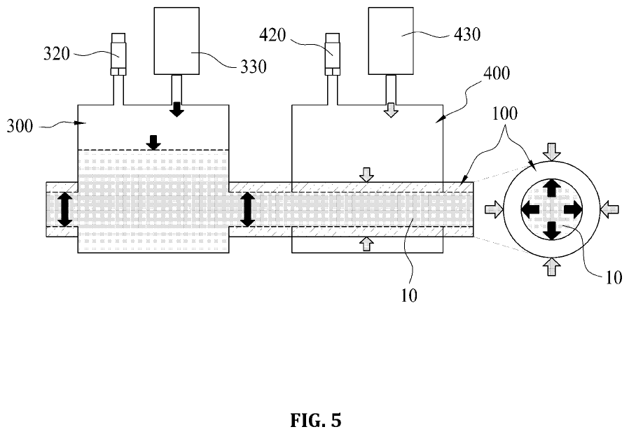

The structures of the vein part 300 and the pressure environment creation part 400 for adjusting the internal and external pressures of the aorta part 100 will be described in detail with reference to FIG. 5.

FIG. 5 is a view for explaining operations of the vein part 300 and the pressure environment creation part 400 for implementing a pressure balance of the aorta part 100 of the pulse wave reproduction device according to the embodiment of the present invention.

As illustrated, the vein part 300 may have the first pressure sensor 320 and the first pump 330 adjacent to the circulation fluid 10.

The first pump 330 is configured to provide the pressure directly to the circulation fluid 10, and the first pressure sensor 320 may measure the pressure of the aorta part 100 adjusted by the first pump 330.

Specifically, the first pump 330 may adjust the pressure in the aorta part 100 by applying the pressure directly to the circulation fluid 10, and the second pump 430 may adjust the pressure on the surface of the aorta part 100 by pressing the aorta part 100 in the pressure environment creation part 400.

FIG. 5 illustrates a change in pressure indicated by the arrows.

As illustrated, with the structure in which the first pump 330 pressurizes the circulation fluid 10 and the pressure is transmitted to the aorta part 100 through the vein hole member 326, when the first pump 330 pressurizes the circulation fluid 10, the pressure may be transmitted into the aorta part 100 so that the aorta part 100 is expanded by the circulation fluid 10.

Further, when the second pump 430 applies the pressure into the pressure environment creation part 400, the pressure may be transmitted to the surface of the aorta part 100, and the second pump 430 may press the aorta part 100 at the periphery of the aorta part 100 in the entire internal space of the pressure environment creation part 400.

Meanwhile, the aorta part 100 according to the present invention may be provided as the aorta parts 100 with various conditions in accordance with physical properties.

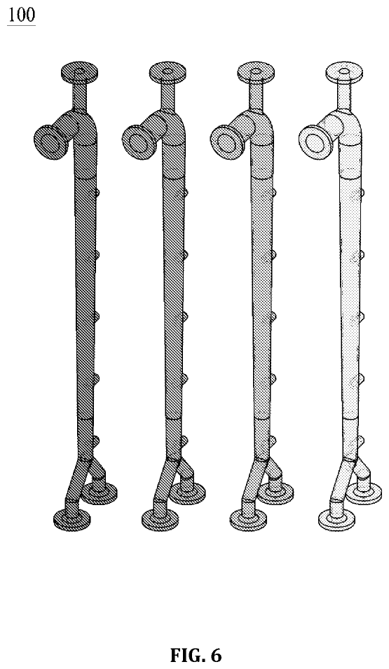

FIG. 6 is a view for explaining a process in which the aorta parts 100 with different physical properties are replaced to perform a simulation for each condition in the pulse wave reproduction device according to the embodiment of the present invention.

As illustrated, the aorta parts 100 with the same magnitude may be provided.

This is to make the aorta part 100 in consideration of the fact that the human aorta varies in stiffness depending on the age and medical conditions of a person. Therefore, the aorta parts 100 with different stiffnesses may be manufactured, and the aorta parts 100 with different stiffnesses may be mounted in the pressure environment creation part 400 in accordance with the conditions.

The pulse wave reproduction device refers to a device that may simulate a change in pulse wave in the actual aorta by preparing the aorta and other organs similar in magnitude and configuration to those of the actual human body.

The method of operating the pulse wave reproduction device will be described below with reference to FIGS. 6 to 9.

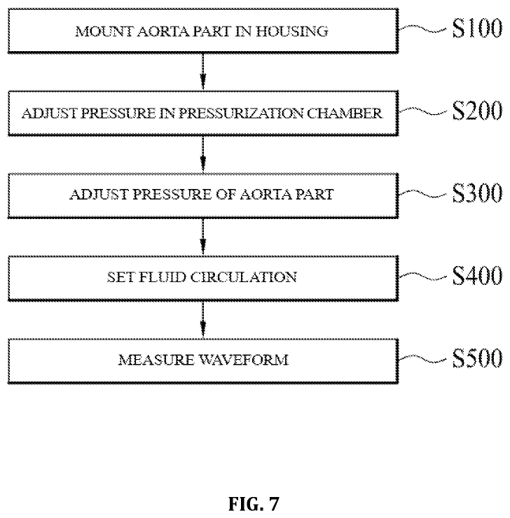

FIG. 7 is a view for explaining a pulse wave reproduction method using the pulse wave reproduction device according to the embodiment of the present invention.

As illustrated, first, the aorta part 100 identical and similar in condition to a target to be simulated may be prepared and mounted in the pressure environment creation part 400 (S100).

A process of mounting the aorta part 100 in the pressure environment creation part 400 may include a process of opening or closing the upper door 450, the intermediate door 470, and the lower door 490, and a process of penetratively inserting the aorta part 100 into the upper casing 440, the intermediate casing 460, and the lower casing 480.

When the aorta part 100 is completely mounted in the pressure environment creation part 400, a process of coupling the upper door 450, the intermediate door 470, and the lower door 490 to the upper casing 440, the intermediate casing 460, and the lower casing 480 may be performed, and then the external pressure to be applied to the surface of the aorta part 100 may be adjusted by adjusting the second pressure sensor 420 (S200).

In this case, the pressure of the second pump 430 may be adjusted by a user, such that the pressure to be applied to the aorta part 100 may be adjusted to be high or low (S300).

Further, the vein part 300 may adjust the pressure to be applied to the circulation fluid 10 by adjusting the first pump 330, such that the pressure in the aorta part 100 may be adjusted (S300).

Thereafter, the pump member 220 of the heart part 200 operates to generate a forward wave by performing a pumping operation in a preset cycle. The age is determined on the basis of the degree of the superposition of the forward wave and the reflective wave reflected by the lower member 180 of the aorta part 100.

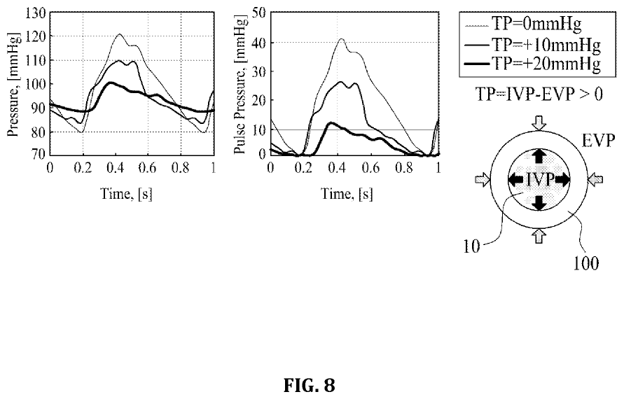

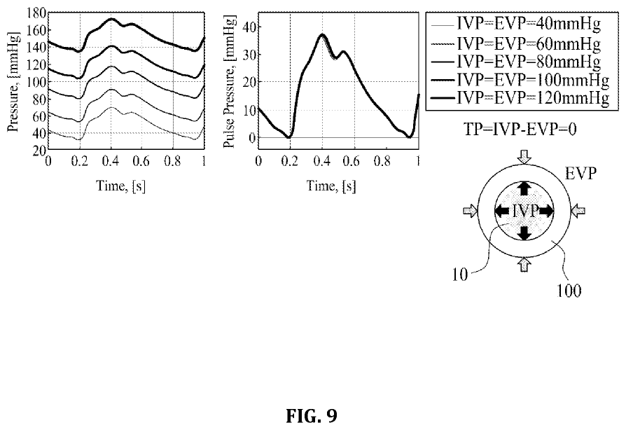

FIGS. 8 and 9 are views for explaining pulse wave measurement values obtained on the basis of the presence or absence of the pressure environment creation part 400 by the pulse wave reproduction method using the pulse wave reproduction device according to the embodiment of the present invention.

First, with reference to pulse wave measurement values in FIG. 8 in the case in which the pressure environment creation part 400 is not present, it can be ascertained that the pressure of the circulation fluid 10, which is higher than the external pressure of the aorta part 100, is applied because the pressure environment creation part 400 is not present.

In this case, the aorta part 100 may be deformed in shape by the internal pressure, and the measured pulse wave may not be constant.

Next, with reference to pulse wave measurement values in FIG. 9, the graph shows pulse waves measured in a state in which the pressure environment creation part 400 is provided and the internal and external pressures are equally applied to the aorta part 100.

The pressure environment creation part 400 may adjust the external pressure of the aorta, such that the constant measurement values are observed in the state in which the internal and external pressures are set uniformly, as illustrated in FIG. 9.

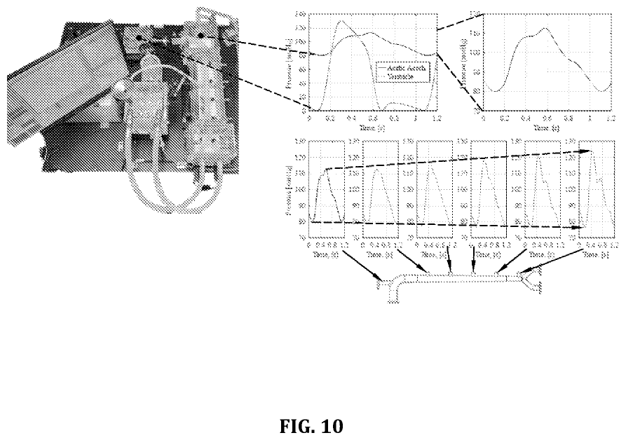

FIG. 10 is a view for explaining a result value for deriving a waveform similar to that of a human body by means of the pulse wave reproduction device in the pulse wave reproduction method using the pulse wave reproduction device according to the embodiment of the present invention.

The illustrated graph is a graph showing a change in pressure over time.

A graph showing a pulse wave in the heart part 200 is illustrated at the upper left side, a graph showing a pulse wave in a state in which the pressure is applied to the inside and outside of the aorta part 100 is illustrated at the upper right side, and graphs according to the positions of the aorta part 100 are illustrated at the lower side.

First, when the pump member 220 of the heart part 200 operates, the internal and external pressures are not provided to the aorta part 100, and the aorta part 100 is expanded, deformed, and softened.

In case that there is a difference in pressure between the inside and outside of the aorta part 100 as described above, the aorta part 100 made of silicone is deformed, and a blood pressure waveform is shown in a shape in which a pulse wave velocity is changed.

In contrast, in a state in which the pressure is applied to the inside and outside of the aorta part 100, the aorta part 100 is inhibited from being expanded, deformed, and softened, such that the blood vessel stiffness and the pulse wave velocity of the target value are maintained when the preset state of the aorta is reproduced, and the blood pressure waveform is also reproduced without distortion.

In addition, the minimum blood pressure may be freely adjusted to maximum blood pressure of 120 mmHg and minimum blood pressure 80 mmHg within a range identical to that of a human body without a change in waveform. The artificial aorta may maintain the targeted E of 340 kPa and the targeted pulse wave velocity of 6.5 m/s and reproduce the blood pressure waveform identical in magnitude and shape to those of a person of middle age.

Meanwhile, the blood pressure waveform graphs according to the position of the aorta part 100 will be described below.

In the aorta part 100, one aorta hole member 120 is provided on the upper member 140, four aorta hole members 120 are provided on the intermediate member 160, and one aorta hole member 120 is provided on the lower member 180.

In the six graphs at the lower side, the upper member 140, the intermediate member 160, and the lower member 180 are shown in this order in the direction from the left to the right.

The third pressure sensors 130 are respectively mounted on the aorta hole members 120 and measure the pressure for each of the aorta hole members 120.

The six graphs are graphs showing blood pressure waveforms for respective positions.

As in the human body, the area of superposition of the reflected wave and the forward wave expands as the distance from the end of the aortic part 100, in which the reflected wave is generated, decreases, and the systolic peak becomes gradually sharper in a double peak shape in which the systolic peak is added to the augmented pressure peak. In addition, the tendency, in which maximum blood pressure increases, minimum blood pressure decreases, and the pulse pressure, which is the amplitude of the blood pressure waveform, increases, is reproduced to identical to that of the human aorta.

While the exemplary embodiments according to the present invention have been described above, it is obvious to those skilled in the art that the present invention may be specified in other particular forms in addition to the aforementioned embodiments without departing from the spirit or the scope of the present invention. Accordingly, it should be understood that the aforementioned embodiments are not restrictive but illustrative, and thus the present invention is not limited to the aforementioned description, and may be modified within the scope of the appended claims and the equivalent range thereto.

### EXPLANATION OF REFERENCE NUMERALS AND SYMBOLS

10: Circulation fluid
100: Aorta part
120: Aorta hole member
130: Third pressure sensor
140: Upper member
160: Intermediate member
180: Lower member
200: Heart part
220: Pump member
240: Valve member
260: Atrium member
300: Vein part
320: First pressure sensor
330: First pump
326: Vein hole member
350: Vein part door
400: Pressure environment creation part
420: Second pressure sensor
430: Second pump
440: Upper casing
450: Upper door
460: Intermediate casing
470: Intermediate door
480: Lower casing
490: Lower door

1-11. (canceled)

12. A pulse wave reproduction device, which measures a blood pressure wave by maintaining a pressure of an aorta to be identical to that in an environment of a human body, the pulse wave reproduction device comprising:
an aorta part provided in the form of a tube elongated to correspond to a shape of a human aorta and configured such that a circulation fluid flows in the aorta part;
a heart part connected to the aorta part and configured to share the circulation fluid with the aorta part and generate a forward wave according to a pulse flow by applying a pressure in a preset cycle;
a vein part configured to share the circulation fluid with the aorta part and adjust a pressure in the aorta part by applying a pressure to the circulation fluid; and
a pressure environment creation part having a space therein to accommodate the aorta part and configured to adjust an external pressure by pressing the aorta part.

13. The pulse wave reproduction device of claim 12, wherein internal and external pressures of the aorta part are adjusted to reproduce a condition of the human aorta.

14. The pulse wave reproduction device of claim 13, wherein the aorta part uses at least one pump to adjust the internal and external pressures.

15. The pulse wave reproduction device of claim 14, wherein the aorta part comprises:
an aorta hole member protruding outward from a periphery of the aorta part; and
a third pressure sensor coupled to the aorta hole member and configured to measure the internal pressure of the aorta part.

16. The pulse wave reproduction device of claim 15, wherein the pressure environment creation part is shaped to surround the aorta part and partially opened so that the aorta part is inserted into the pressure environment creation part, and at least a part of the pressure environment creation part further comprises a second pump configured to apply a pressure to the aorta part.

17. The pulse wave reproduction device of claim 16, wherein the pressure environment creation part comprises a door configured to open or close a part of the pressure environment creation part to replace the aorta part, and the second pump is coupled to the door and applies a pressure into the pressure environment creation part.

18. The pulse wave reproduction device of claim 12, wherein the pressure environment creation part is provided as a plurality of pressure environment creation parts coupled to one another in accordance with a length of the aorta part and formed in different shapes while corresponding to a shape of the aorta part.

19. The pulse wave reproduction device of claim 14, wherein the vein part is connected to the aorta part and configured to share the circulation fluid in the aorta part, adjust an internal pressure of the aorta part, and measure the internal pressure of the aorta part.

20. The pulse wave reproduction device of claim 19, wherein the vein part comprises:
a vein hole member extending from a distal end of the aorta part;
a first pump connected to the vein hole member and configured to pressurize the circulation fluid in the aorta part; and
a first pressure sensor disposed adjacent to the first pump and configured to measure a pressure in the aorta part.

21. The pulse wave reproduction device of claim 12, wherein the heart part comprises:
a pump member configured to provide a pulse flow to the aorta part through the circulation fluid; and
valve members provided between the pump member and the aorta part, between the pump member and the vein part, and between the vein part and the aorta part and configured to allow the pulse flow to be provided only in one direction from the pump member toward the aorta part.

22. A method of operating the pulse wave reproduction device of claims 12.
